(19) United States
(12) Patent Application Publication
(10) Pub. No.: US 2018/0330725 A1
(43) Pub. Date: Nov. 15, 2018

(54) INTENT BASED SPEECH RECOGNITION PRIMING

(71) Applicant: MICROSOFT TECHNOLOGY LICENSING, LLC, Redmond, WA (US)

(72) Inventors: Padma VARADHARAJAN, Palo Alto, CA (US); Shuangyu CHANG, Fremont, CA (US); Khuram SHAHID, Seattle, WA (US); Meryem Pinar DONMEZ EDIZ, Los Altos, CA (US); Nitin AGARWAL, Fremont, CA (US)

(21) Appl. No.: 15/681,197

(22) Filed: Aug. 18, 2017

Related U.S. Application Data
(60) Provisional application No. 62/503,608, filed on May 9, 2017.

(51) Int. Cl. G10L 15/19; G10L 15/18; G10L 15/26

(52) U.S. Cl. CPC G10L 15/19; G10L 15/265; G10L 15/1815

(57) ABSTRACT

A method for priming an extensible speech recognition system comprises receiving audio language input from a user. The method also comprises receiving an indication that the audio language input is associated with a first language-based intelligent agent. The first language-based intelligent agent is associated with a first grammar set that is specific to the first language-based intelligent agent. Additionally, the method comprises matching one or more spoken words or phrases within the audio language input to text-based words or phrases within a general grammar set associated with a speech recognition system and the first grammar set. The first grammar set is associated with a higher match bias than the general grammar set, such that the speech recognition system is more likely to match the one or more spoken words or phrases to the text-based words or phrases within the first grammar set.

### CROSS-REFERENCE TO RELATED APPLICATIONS

This application claims priority to and the benefit of U.S. Provisional Application Ser. No. 62/503,608 entitled “INTENT BASED SPEECH RECOGNITION PRIMING”, filed on May 9, 2017, the entire contents of which is incorporated by reference herein in its entirety.

### BACKGROUND

Computers and computing systems have affected nearly every aspect of modern living. Computers are generally involved in work, recreation, healthcare, transportation, entertainment, household management, etc. Recent advances in speech recognition and artificial intelligence have opened a new frontier of human-to-computer interactions that previously were confined to science fiction.

Users are now able to converse with their mobile phone (or any number of other enabled device) in normal conversation language. The speech recognition and artificial intelligence capabilities of these devices allows the device to provide requested information to the user and even to automatically perform requested actions. For example, a user may verbally state “schedule me a haircut for 4 PM tomorrow.” In embodiments, the speech recognition and artificial intelligence systems will perform the necessary actions to schedule the appointment.

While new frontiers in speech recognition and artificial intelligence have recently been opened, there are still challenges within the field. For example, the expanse of human vocabulary is significant. Additionally, in normal use, accents and enunciations between different users vary dramatically. These real-world variations in speech significantly increase the challenge associated with properly identifying the words that a user is saying. Advancements that improve the ability of speech recognition to properly match spoken language to words and phrases is needed within the field.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least one disclosed embodiments comprise a method for priming an extensible speech recognition system. The method comprises receiving, at a speech recognition system, audio language input from a user. The speech recognition system is associated with a general speech recognition model that comprises a general grammar set. The method also comprises receiving, at the speech recognition system, an indication that the audio language input is associated with a first language-based intelligent agent. The first language-based intelligent agent is associated with a first grammar set that is specific to the first language-based intelligent agent and different than the general grammar set. Additionally, the method comprises matching one or more spoken words or phrases within the audio language input to text-based words or phrases within the general grammar set and the first grammar set. The first grammar set is associated with a higher match bias than the general grammar set, such that the speech recognition system is more likely to match the one or more spoken words or phrases to the text-based words or phrases within the first grammar set.

An additional disclosed embodiment comprises a system for priming an extensible speech recognition system. The system is configured to create a first language-based intelligent agent. Creating the first language-based intelligent agent comprises adding words and phrases to a first grammar set that is associated with the first language-based intelligent agent. Additionally, creating the first language-based intelligent agent comprises creating an identification invocation that is associated with the first language-based intelligent agent. The system also associates the first language-based intelligent agent with a speech recognition system. The speech recognition system is associated with a general speech recognition model that comprises a general grammar set that is different that the first grammar set. The system also receives audio language input from a user. The system then matches one or more spoken words within the audio language input to text-based words within the general grammar set and the first grammar set. The first grammar set is associated with a higher match bias than the general grammar set, such that the speech recognition system is more likely to match the one or more spoken words to the text-based words within the first grammar set.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a schematic diagram of an embodiment of a system for priming an extensible speech recognition system.

FIG. 2 illustrates an embodiment of a particular grammar set that is specific to a particular language-based intelligent agent.

FIG. 3 illustrates data used for generating an embodiment of a dynamically generated priming set.

FIG. 4 illustrates steps in an exemplary method that can be followed to prime an extensible speech recognition system.

FIG. 5 illustrates steps in another exemplary method that can be followed to prime an extensible speech recognition system.

### DETAILED DESCRIPTION

Disclosed embodiments provide significant technical advancements to the field of speech recognition. For example, at least one embodiment allows a third-party developer to create a unique language-based intelligent agent that operates within a speech recognition system. As used herein a language-based intelligent agent (also referred to as a “bot”) comprises software and/or hardware based component within language understanding systems and/or speech recognition systems that are capable of interpreting and acting upon natural language inputs through text or speech. Further, as used herein, a speech recognition system is a general term for describing both speech recognition functionality, language understanding functionality, and intelligent agent system 100 components. In contrast, as used herein, a speech recognition engine is limited in functionality to the recognition of audio language input. In at least one embodiment, the developer provides the language-based intelligent agent with an agent-specific grammar set. As used herein, an agent-specific grammar set comprises a collection of words and/or phrases that are specific to the subject matter that corresponds to the specific language-based intelligent agent. When the developer's language-based intelligent agent is invoked, the grammar set associated with the language-based intelligent agent is biased higher than a standard grammar set associated with the speech recognition system. Accordingly, the developer is able to set words and phrases that a user is more likely to use in conjunction with the developer's language-based intelligent agent.

Biasing the words and phrases within the language-based intelligent agent grammar increases the likelihood that a user's speech with be properly identified. For example, in at least one embodiment, a developer creates a language-based intelligent agent identified as “Game Bot.” The Game Bot language-based intelligent agent is configured to provide a user with information about various video games.

In a first example, a user asks the speech recognition system, without invoking the Game Bot language-based intelligent agent, “show me tips on how to defeat Belial in act 3.” However, as discussed above, speech is confusable and without context is often misunderstood. As such, the speech recognition system incorrectly identified the spoken words as “show me tips on how to defeat the lilac tree.”

In contrast, in a second example, a user asks the speech recognition system, “show me tips on how to defeat Belial in act 3,” but this time the Game Bot language-based intelligent agent is activated. When activated Game Bot language-based intelligent agent loads a grammar set that comprises the names of various video games, video game characters, video games levels, etc. The speech recognition system biases this grammar set, such that it is more likely to match the spoken words of the user to words within the Game Bot language-based intelligent agent's grammar set than it is to match the spoken words of the user to words within a general-purpose grammar set associated with the speech recognition engine. Because of the presence of the Game Bot language-based intelligent agent, the speech recognition engine properly identifies the user's spoken words as “show me tips on how to defeat Belial in act 3.”

In at least one embodiment, the speech recognition system passes on the identified words to the Game Bot language-based intelligent agent. The Game Bot language-based intelligent agent is able to leverage the correctly recognized words to provide the user with the desired information. One will appreciate that in some embodiments the speech recognition system recognizes individual words, while in other embodiments it also recognizes phrases. As such, “words” and “phrases” are used interchangeably herein and do not limit the described embodiments to use of only “words” or only “phrases.”

In at least one embodiment, developers train their language-based intelligent agent by providing expected user utterances in the form of text. The developer labels key components of the expected user utterances with the associated intent and entities. For example, the developer may have entered the words used in the above example following the format provided below:

Intent=GetTips

Entity: Name=Boss, Value=Belial

Entity: Name=Act, Value=3.

Using the developer created grammar set, the speech recognition system is able to correctly identify the spoken words and an associated entity that goes with those words. For instance, the above entry associates “Belial” with the entity of “Boss.” In at least one embodiment, a developer may also be provided with a grammar set template. The grammar set template may comprise pre-defined entities such “Number,” “Cities,” “DateTime,” etc. Within these templates, the developer need only enter the values. For example, values for Cities may comprise “Jackson Hole Wyoming,” “Vale Colorado,” “Tahoe California,” etc. Using these grammar set templates, a user is able to quickly and easily add words and phrases that are specific to their language-based intelligent agent without having to define and establish new entities.

Accordingly, disclosed embodiment provide users with powerful tools for accessing the capabilities of speech recognition systems and language understanding systems without requiring that the user understand the complex processing that is used within the respective systems. As such, users are able to leverage speech input within their own products by simply creating a language-based intelligent agent and associated grammar set.

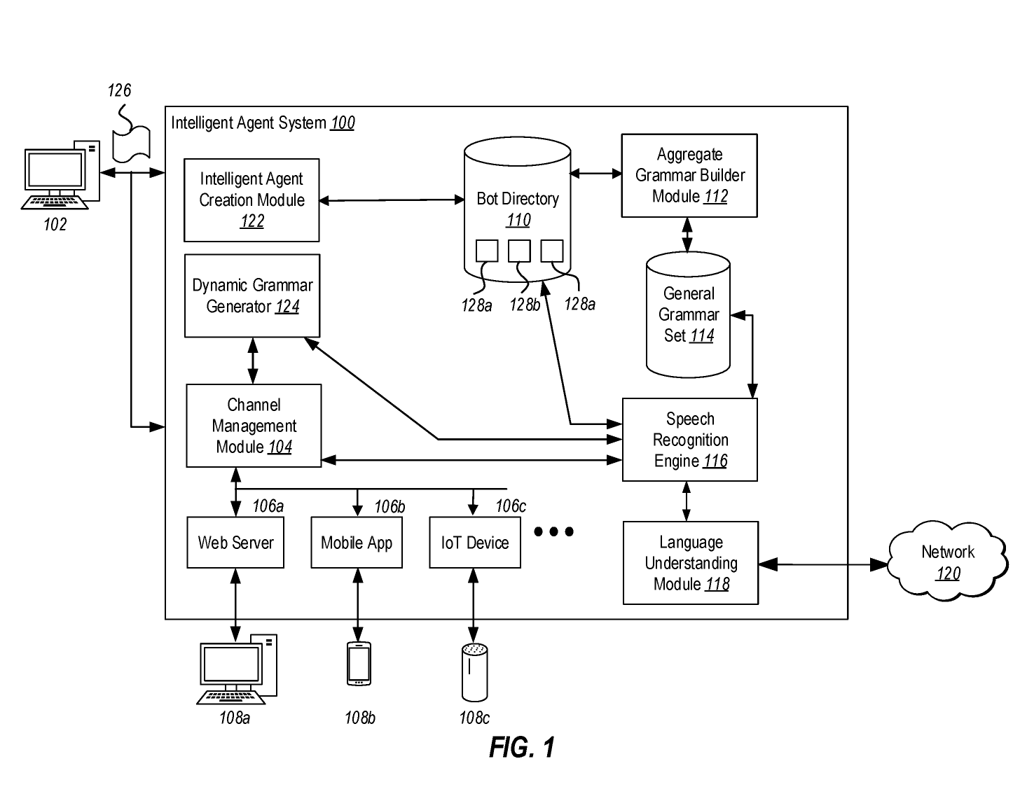

Turning now to the figures, FIG. 1 illustrates a schematic diagram of an embodiment of an intelligent agent system 100 for creating intelligent agents and priming an extensible speech recognition system. In the depicted chart, a developer 102 may represent a single individual or multiple different individuals. Similarly, any users described herein may also represent a single individual or multiple different individuals. Additionally, in FIG. 1, and throughout this specification, the word “bot” is used interchangeably with “language-based intelligent agent.”

In at least one embodiment, the developer 102 is provided with a platform to build a language-based intelligent agent using an underlying speech recognition engine 116 that the developer does not have direct control over. For example, the speech recognition engine 116 may be executed on remote servers that the developer 102 does not have access to or control over. As such, disclosed embodiments provide an intelligent agent system 100 in which a developer 102 can develop a language-based intelligent agent with an associated grammar set and integrate that data into a 3^{rd} party speech recognition engine 116. For example, a developer 102 is able to communicate a language-based intelligent agent specific grammar set 126 to the intelligent agent system 100.

In at least one embodiment, while building a language-based intelligent agent, a developer 102 may utilize a channel management module 104 to enable it across various channels 106(a-c) such that users can access the language-based intelligent agent via any number of specific clients. For example, the developer 102 may open up channels 106(a-c) so that the language-based intelligent agent can receive audio language input from within specific websites or applications from a person computer 108a, a mobile device 108b, an internet-of-things device 108c, or any other appropriate platform. In at least one embodiment, when the developer 102 enables their language-based intelligent agent for a particular channel 108(a-c) (e.g., Cortana™) in the channel management module 104, the developer 102 specifies an invocation identification that end users must use in their query in order to address the language-based intelligent agent. For example, the developer 102 may specify that the invocation identification associated with their language-based intelligent agent is “Jarvis.” In such a case, a user in Cortana™ communicate an indication to use the language-based intelligent agent by saying, “Hey Cortana ask Jarvis to email me the grocery list”. This invocation identification is stored in a Bot directory 110. In at least one embodiment, language-based intelligent agents 128(a-c) are added to the bot directory 110 by the intelligent agent system 100 such that multiple different language-based intelligent agents are accessible to a single speech recognition engine 116.

In at least one embodiment, an aggregate grammar builder module 112 gathers grammar information from the bot directory 110 in order to build a speech model that is updated to function with the underlying speech recognition engine 116. For example, the resulting grammar built by the aggregate grammar builder module 112 can contain Cortana™ invocation phrases such as “Ask <invocationName> to <query>”.

In at least one embodiment, an aggregate grammar builder module 112 periodically aggregates language understanding (LU) information related to all language-based intelligent agent that are published to a particular channel and builds a general grammar set 114 that is available for general processing by the speech recognition engine 116. The aggregate grammar builder module 112 is configured to query training data associated with apps used by channel-enabled bots.

The general grammar set 114 is loaded while processing speech recognition queries from the channel's clients. This allows accurate speech recognition of any audio language input from a user related to any bot that has been associated with the channel. For example, a particular language-based intelligent agent may appear as a “skill” that is available to user through the speech recognition engine 116. Once the user has successfully triggered a specific skill, subsequent speech recognition requests from this user will also load the bot-specific grammar set. In order to load this bot-specific grammar set, the speech recognition engine 116 loads both the specific bot-specific grammar set from the bot directory 110 and the general grammar set 114.

In at least one embodiment, the speech recognition system will leverage a Universal Language Model (ULM), which supports general speech recognition. The ULM is also referred to herein as the general grammar set 114. The agent specific grammar sets discussed below will be loaded in parallel with the ULM in order to improve the likelihood of some scenario-specific phrases being recognized. The words and phrases within loaded language-based intelligent agent specific grammar sets are biased higher than words and phrases within the ULM, such that these scenario-specific words are more likely to be identified. As such, in cases where no word matches can be found within a language-based intelligent agent specific grammar set, the speech recognition should fall back to the accuracy offered by the ULM.

In addition to leveraging a language-based intelligent agent specific grammar sets and the general grammar set 114, in at least one embodiment, the intelligent agent system 100 also utilizes a dynamically generated priming set. For example, the dynamic grammar generator 124 dynamically generates a grammar set based upon information received from the user devices 108(a-c). In at least one embodiment, the dynamic grammar generator 124 is associated with a particular language-based intelligent agent, such that the speech recognition engine 116 receives a dynamically generated priming set that comprises particular words or phrases that the first language-based intelligent agent dynamically generates based upon attributes associated with the first language-based intelligent agent. For example, the dynamically generated priming set may comprise words and phrases that are associated with user-specific attributes, such as the geolocation of the user, the time of day, the user's calendar, or any number of other user-specific attributes.

In at least one embodiment, the particular words or phrases within the dynamically generated priming set are biased higher than the general grammar set and the language-based intelligent agent grammar set for matching purposes. As such, when processing an audio language input from a user, the language recognition engine 116 will attempt to match one or more spoken words or phrases within the audio language input to text-based words or phrases within the various available grammar sets. For example, the language recognition engine 116 will attempt to match the audio language input to the general grammar set, the language-based intelligent agent specific grammar set, and the dynamically generated priming set. The various possible matches will each be associated with a particular weighting that indicates the likelihood that the match is correct. In addition to the weighting, words and phrases matched from the language-based intelligent agent specific grammar set and the dynamically generated priming set will also be associated with match biases that makes matches more likely when they are from the language-based intelligent agent specific grammar set or the dynamically generated priming set. Additionally, in at least one embodiment, the dynamically generated priming set is associated with a higher match bias than the language-based intelligent agent specific grammar set, such that matches are more likely to be made with the dynamically generated priming set. One will appreciate, however, that particular words and phrases may appear in any combination of the dynamically generated priming set, the language-based intelligent agent specific grammar set, and the general grammar set. As such, it is possible that matches may occur to the same words and phrases across multiple grammar sets.

The intelligent agent system 100 is also configured to utilize a language understanding module 118. The language understanding module 118 receives text-based words and phrases that the speech recognition engine 116 gathers from the audio language input. The language understanding module 118 is then able to act upon the received words and phrases. For example, the language understanding module 118 may retrieve information from a network 120, such as the Internet, to answer a user's question. Similarly, the language understanding module 118 may utilize the network to perform an action, such as making a dentist appointment for a user.

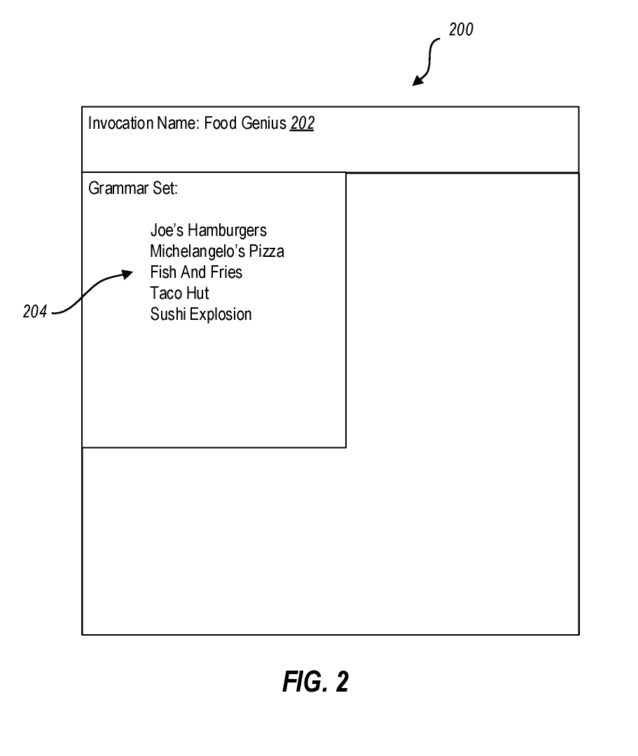

FIG. 2 illustrates an embodiment of a particular grammar set 200 that is specific to a particular language-based intelligent agent. When a developer chooses to create a language-based intelligent agent, the developer also adds words and phrases to a particular grammar set 200 to be associated with the language-based intelligent agent. The depicted particular grammar set 200 is a genericized version of a grammar set that a developer might create. For example, the developer 102 has given the particular grammar set 200 an invocation name of “Food Genius.” As such, when a user desires to use this particular language-based intelligent agent, the user provides an indication of “Food Genius” within their audio language input.

The particular grammar set 200 also includes particular words and phrases 204 that are unique to the particular language-based intelligent agent. For example, the particular language-based intelligent agent is related to restaurant recommendation. As such, a user may issue an audio language input “Ask Good Genius whether Joe's Hamburgers makes good food.” Upon receiving the audio language input, the speech recognition engine, matches the audio language input words and phrases to words and phrases within the general grammar set 114 and the particular grammar set 200. Because the name “Joe's Hamburgers” appear within the particular words and phrases 204, the speech recognition engine is more likely to match the user's audio language input with that correct name. One will appreciate that the general grammar set 114 may not comprise all of the restaurant names that are present within the particular grammar set 204.

In at least one embodiment, when creating a particular grammar set 204 to associate with a particular language-based intelligent agent, the developer is also able to associate a particular match bias with the particular words and phrases. For example, the developer 102 may associate a high match bias with the particular grammar set 204 if the particular language-based intelligent agent is associated with a particular grammar set 204 that is extremely unique and unlikely to match to a general grammar set 114. For instance, the developer 102 may be creating a particular language-based intelligent agent for medical doctors. In such a case, the developer may desire to associate a higher bias with the particular grammar set 204 because medical terminology is likely to generate a high number of false matches when used with the general grammar set 114. As such, a user is able to set a particular bias level based upon the needs of a particular language-based intelligent agent. In at least one embodiment, setting the bias is as simple as selecting a match bias on a scale of one to ten.

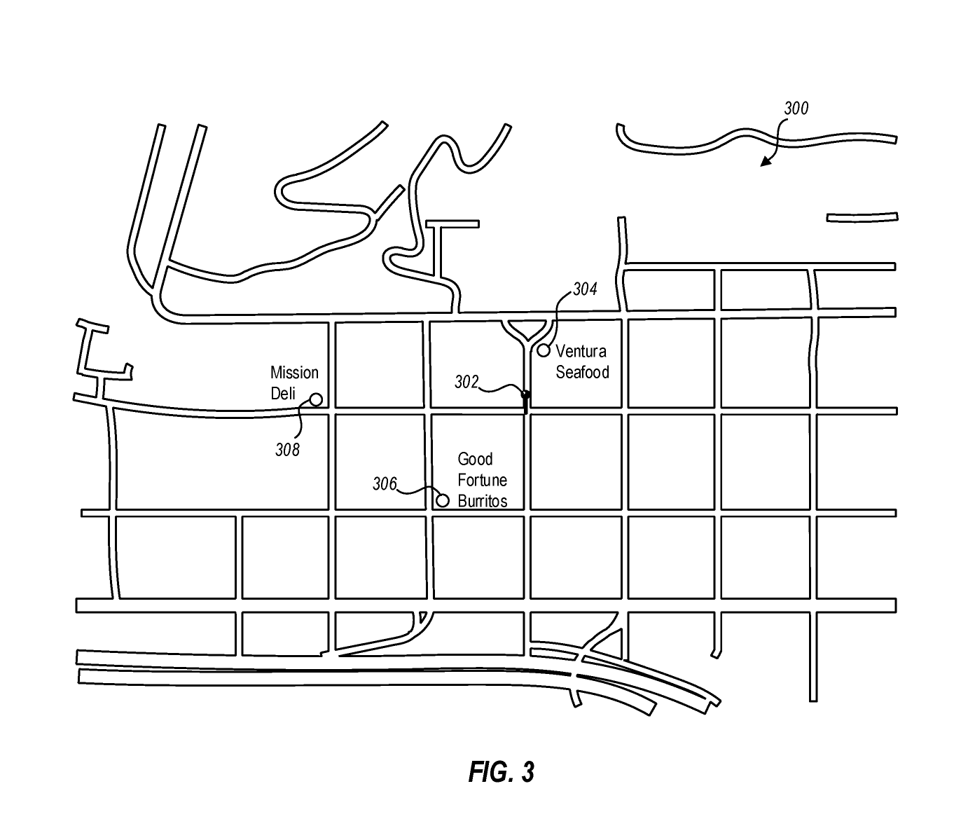

FIG. 3 illustrates data used for generating an embodiment of a dynamically generated priming set. In particular, FIG. 3 depicts a map 300 with the user's location 302 shown along with various nearby restaurants 304, 306, 308. In at least one embodiment, the map 300 of FIG. 3 is associated with a restaurant recommendation mobile application that utilizes the particular language-based intelligent agent illustrated in FIG. 2. As such, a user receives restaurant recommendations by invoking the Food Genius language-based intelligent agent.

In at least one embodiment, prior to receiving the audio language input, the speech recognition engine 116 receives a notification through the particular language-based intelligent agent. For example, the restaurant recommendation mobile application may automatically communicate the invocation (e.g., “ask Food Genius”) necessary for the speech recognition engine 116 to associate with the particular grammar set 204.

Additionally, in at least one embodiment, the restaurant recommendation mobile application may additionally or alternatively send a notification comprising a dynamically generated priming set. The dynamically generated priming set comprises particular words or phrases that are dynamically generated based upon attributes associated with the language-based intelligent agent and/or the user. For example, in the depicted embodiment, the language-based intelligent agent relates to restaurant recommendations. In at least one embodiment, the user's geo-location may be an attribute associated with such a language-based intelligent agent. As such, the restaurant recommendation mobile application may create a dynamically generated priming set based upon points-of-interest (in this example, restaurants) that are within a threshold distance of the current geo-location of the user. For instance, the dynamically generated priming set of FIG. 3 may include “Mission Deli,” Ventura Seafood,” and “Good Fortune Burritos.”

One will appreciate that a general grammar set 114 is unlikely to have an exhaustive listing of restaurant names. Additionally, even a restaurant-specific grammar set that is associated with a restaurant-recommendation language-based intelligent agent is unlikely to have an exhaustive listing of every possible local restaurant. Accordingly, the ability to rely upon a dynamically generated priming set when matching words and phrases provides a significant benefit. Further still, even if the local restaurants appear within the general grammar set and/or the restaurant-specific grammar set from the restaurant-recommendation language-based intelligent agent, placing a higher match bias on restaurants that are nearby the user will likely result in a more accurate matching of words and phrases.

For example, a user requesting the menu for “Mission Deli” is more likely to be properly interpreted because the dynamically generated priming set includes that name and is also associated with the highest match bias. Similarly, in at least one embodiment, an intelligent agent system 100 may also be configured to associate a dynamically-generated-priming-set match bias with the words and phrases within the dynamically generated priming set. For instance, the restaurant recommendation mobile application may assume that the user is most interested in nearby restaurants during lunch hour, and as such, increase the dynamically-generated-priming-set match bias. In contrast, the restaurant recommendation mobile application may assume that a user is more interested in general browsing about restaurant information if the user is interacting with the restaurant recommendation mobile application during mid-afternoon. In such a case, the restaurant recommendation mobile application communicates a respectively lower dynamically-generated-priming-set match bias.

One will appreciate that dynamically generated priming sets may be generated based upon more than just the user's geo-location. For example, other attributes of interest may include contacts stored within the user's mobile device, items on the user's itinerary, details about the user's local network connection, information about other devices connected to the user's mobile device, and other similar information. As such, a user attribute may include any information that is digitally transmittable to the intelligent agent system 100.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

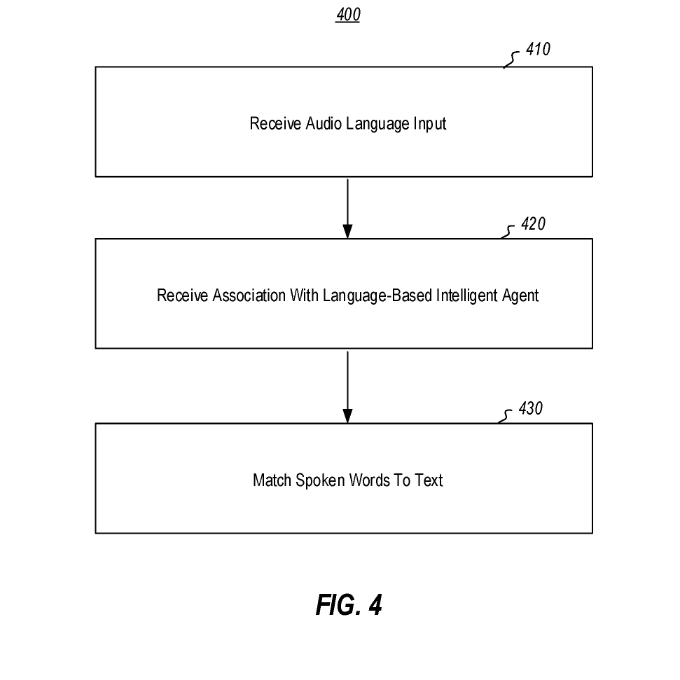

For example, FIG. 4 illustrates steps in an exemplary method 400 that can be followed to prime an extensible speech recognition system. The depicted steps include a step 410 of receiving audio language input 410. Step 410 comprises receiving, at a speech recognition system, audio language input from a user, wherein the speech recognition system is associated with a general speech recognition model that comprises a general grammar set. For example, as depicted and described with respect to FIG. 1, a user can issue a command or ask a question from a mobile device 108b. The command is processed by the speech recognition engine 116 that relies upon a general grammar set 114 to interpret normal conversation.

Additionally, the method 400 includes an act 420 of receiving an association with a language-based intelligent agent. Act 420 comprises receiving, at the speech recognition system, an indication that the audio language input is associated with a first language-based intelligent agent, wherein the first language-based intelligent agent is associated with a first grammar set that is specific to the first language-based intelligent agent and different than the general grammar set. For example, as explained above, a user can invoke a Food Genius Bot by verbally requesting the Food Genius bot by name. Various other methods exist for associating a first language-based intelligent with an input. For example, the first language-based intelligent may proactively invoke itself through communication with the speech recognition system. The first language-based intelligent agent, in this example the Food Genius Bot, is associated with a unique grammar set that contains words and phrases relating to restaurants.

The method 240 also includes an act 430 of matching spoken words to text. Act 430 comprises matching one or more spoken words or phrases within the audio language input to text-based words or phrases within the general grammar set and the first grammar set, wherein the first grammar set is associated with a higher match bias than the general grammar set, such that the speech recognition system is more likely to match the one or more spoken words or phrases to the text-based words or phrases within the first grammar set. As explained above, when matching the user's verbal words and phrases to text, the speech recognition system biases the grammar set that is received from a language-based intelligent agent above the words and phrases in the general grammar set 114. For example, when using the Game Bot, the speech recognition will match the user's words to “Belial,” which is a word in the Game Bot's grammar set, over “lilac tree,” which appears in the ULM.

In at least one embodiment, the speech recognition is associated with a particular language-based intelligent agent before audio language input is even received. For example, in at least one embodiment, a language-based intelligent agent may be integrated with a 3^{rd} party app. The 3^{rd} party app may utilize the speech recognition system to process audio language input. In such a case, the language-based intelligent agent sends a notification to the speech recognition system before the audio language input is provided to the speech recognition system.

The notification that the language-based intelligent agent sends to the speech recognition system may also comprise a dynamically generated priming set. In at least one embodiment, the dynamically generated priming set is distinct from the language-based intelligent agent specific grammar set and comprises particular words or phrases that the first language-based intelligent agent communicates to the speech recognition system. Additionally, the particular words or phrases within the dynamically generated priming set are biased higher than the language-based intelligent agent's grammar set for matching purposes.

For example, returning to the example of a third-party app, a user may be interacting with a restaurant recommendation app. Upon activating a speech recognition feature of the restaurant recommendation app, a language-based intelligent agent associated with the app detects the user's geolocation, using GPS or some other similar system, and identifies all restaurants within five miles of the user. The language-based intelligent agent then communicates the identified restaurants to the speech recognition system within the dynamically generated priming set.

Accordingly, the dynamically generated priming set may comprise words and phrases that are dynamically generated based upon dynamic variables that are not available to the speech recognition system. In contrast to the language-based intelligent agent's grammar set, which in many cases may be substantially static, the dynamically generated priming set may comprise dynamically generated words and phrases that are unique to each circumstance. It at least one embodiment, one or more of the dynamically generated words and phrases also appear in the language-based intelligent agent's grammar set. The dynamically generated words and phrases, however, are biased higher than even the language-based intelligent agent's grammar set. One should appreciate that the examples provided herein are not limiting of any disclosed invention. Instead, the examples are provided only for the sake of example and explanation.

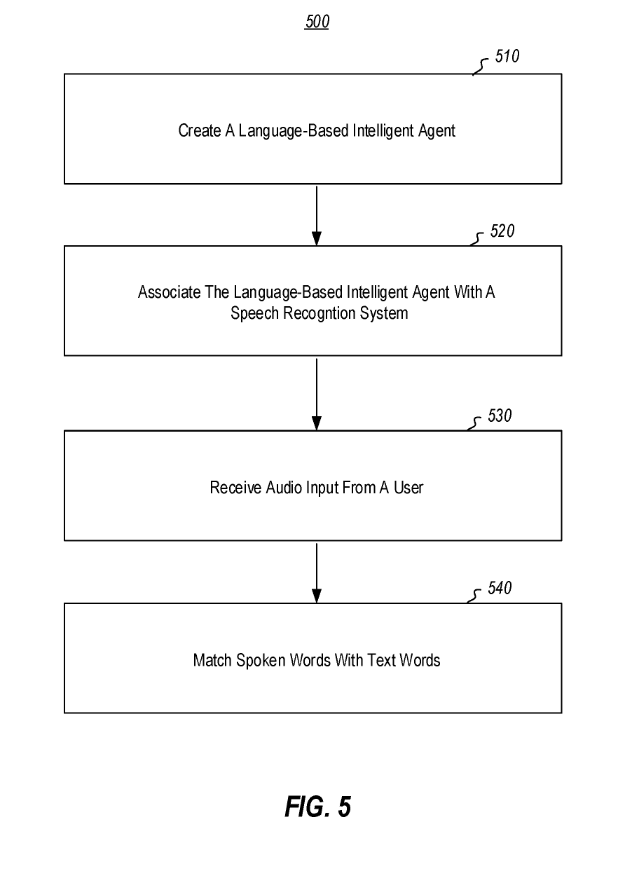

Turning now to the next figure, FIG. 5 illustrates steps in another exemplary method 500 that can be followed to prime an extensible speech recognition system. Method 500 includes a step 510 of creating a language-based intelligent agent. Act 510 comprises creating a first language-based intelligent agent, wherein creating a first language-based intelligent agent comprises: adding words and phrases to a first grammar set that is associated with the first language-based intelligent agent, and creating an identification invocation that is associated with the first language-based intelligent agent.

For example, as depicted and described with respect to FIG. 2, a user is able to create a language-based intelligent agent, such as the Food Genius Bot. In the example of the Food Genius Bot, the user added words and phrases, such as “Michelangelo's Pizza,” to a grammar set that was associated with the language-based intelligent agent. The user also associated the invocation identification of “Food Genius” with the language-based intelligent agent. The resulting language-based intelligent agent was capable of answering questions regarding video games when its name, Game Bot, was invoked within the speech recognition system.

Method 500 also includes an act 520 of associating the language-based intelligent agent with a speech recognition system. Act 520 comprises associating the first language-based intelligent agent with a speech recognition system, wherein the speech recognition system is associated with a general speech recognition model that comprises a general grammar set. For example, as discussed above, the Food Genius language-based intelligent agent can be associated with the speech recognition engine 116 that uses a general grammar set 114.

Additionally, method 500 includes an act 530 of receiving audio input from a user. Act 530 comprises receiving audio language input from a user. For example, as illustrated above, a user can verbally request assistance with a particular boss in a video game, a user can request a recommended restaurant, or a user can issue a verbal command. The audio language input is then provided to the speech recognition engine.

Further, method 500 includes an act 540 of matching spoken words with text words. Act 340 comprises matching one or more spoken words within the audio language input to text-based words within the general grammar set and the first grammar set, wherein: the first grammar set is associated with a higher match bias than the general grammar set, such that the speech recognition system is more likely to match the one or more spoken words to the text-based words within the first grammar set. As explained above, when matching the user's verbal words and phrases to text, the speech recognition system biases the grammar set that is received from a language-based intelligent agent above the words and phrases in the ULM. For example, when using the Game Bot, the speech recognition will match the user's words to “Belial,” which is a word in the Game Bot's grammar set, over “lilac tree,” which appears in the ULM.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Computing system functionality can be enhanced by a computing systems' ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a set of web based services for communicating back and forth with clients.

Many computers are intended to be used by direct user interaction with the computer. As such, computers have input hardware and software user interfaces to facilitate user interaction. For example, a modern general purpose computer may include a keyboard, mouse, touchpad, camera, etc. for allowing a user to input data into the computer. In addition, various software user interfaces may be available.

Examples of software user interfaces include graphical user interfaces, text command line based user interface, function key or hot key user interfaces, and the like.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system for priming an extensible speech recognition system, comprising:
one or more processors; and
one or more computer-readable media having stored thereon executable instructions that when executed by the one or more processors configure the computer system to perform at least the following:
receive, at a speech recognition system, audio language input from a user, wherein the speech recognition system is associated with a general speech recognition model that comprises a general grammar set;
receive, at the speech recognition system, an indication that the audio language input is associated with a first language-based intelligent agent, wherein the first language-based intelligent agent is associated with a first grammar set that is specific to the first language-based intelligent agent and different than the general grammar set;
match one or more spoken words or phrases within the audio language input to text-based words or phrases within both the general grammar set and the first grammar set, wherein:
the first grammar set is associated with a higher match bias than the general grammar set, such that the speech recognition system is more likely to match the one or more spoken words or phrases to the text-based words or phrases within the first grammar set.

2. The computer system of claim 1, wherein the executable instructions include instructions that are executable to configure the computer system to receive a match bias associated with the first grammar set.

3. The computer system of claim 1, wherein the executable instructions include instructions that are executable to configure the computer system to:
receive a dynamically generated priming set that comprises particular words or phrases that are dynamically generated based upon attributes associated with the first language-based intelligent agent; and
wherein:
the particular words or phrases within the dynamically generated priming set are biased higher than the general grammar set and the first grammar set for matching purposes, and
the dynamically generated priming set comprises words or phrases that are generated based upon an attribute associated with of the user.

4. The method as recited in claim 3, wherein the dynamically generated priming set comprises words or phrases that are generated based upon a current geo-location of the user.

5. A method for priming an extensible speech recognition system, comprising:
receiving, at a speech recognition system, audio language input from a user, wherein the speech recognition system is associated with a general speech recognition model that comprises a general grammar set;
receiving, at the speech recognition system, an indication that the audio language input is associated with a first language-based intelligent agent, wherein the first language-based intelligent agent is associated with a first grammar set that is specific to the first language-based intelligent agent and different than the general grammar set;
matching one or more spoken words or phrases within the audio language input to text-based words or phrases within both the general grammar set and the first grammar set, wherein:
the first grammar set is associated with a higher match bias than the general grammar set, such that the speech recognition system is more likely to match the one or more spoken words or phrases to the text-based words or phrases within the first grammar set.

6. The method as recited in claim 5, wherein receiving, at the speech recognition system, the indication that the audio language input is associated with the first language-based intelligent agent, comprises identifying within the audio language input an identification invocation that is associated with the first language-based intelligent agent.

7. The method as recited in claim 5, wherein receiving, at the speech recognition system, the indication that the audio language input is associated with the first language-based intelligent agent, comprises:
prior to receiving the audio language input, receiving a notification through the first language-based intelligent agent.

8. The method as recited in claim 7, wherein the notification comprises a dynamically generated priming set that comprises particular words or phrases that are dynamically generated based upon attributes associated with the first language-based intelligent agent.

9. The method as recited in claim 8, wherein the particular words or phrases within the dynamically generated priming set are biased higher than the general grammar set for matching purposes.

10. The method as recited in claim 9, wherein the particular words or phrases within the dynamically generated priming set are biased higher than the first grammar set for matching purposes.

11. The method as recited in claim 10, wherein at least one word or phrase within the dynamically generated priming set also appears within the first grammar set.

12. The method as recited in claim 8, wherein matching the one or more spoken words or phrases within the audio language input to text-based words or phrases also comprises matching the one or more spoken words or phrases to particular words or phrases within the dynamically generated priming set.

13. The method as recited in claim 7, wherein the dynamically generated priming set comprises words or phrases that are generated based upon a current geo-location of the user.

14. A computer system for priming an extensible speech recognition system, comprising:
one or more processors; and
one or more computer-readable media having stored thereon executable instructions that when executed by the one or more processors configure the computer system to perform at least the following:
create a first language-based intelligent agent, wherein creating the first language-based intelligent agent comprises:
adding words and phrases to a first grammar set that is associated with the first language-based intelligent agent; and
creating an identification invocation that is associated with the first language-based intelligent agent;
associate the first language-based intelligent agent with a speech recognition system, wherein the speech recognition system is associated with a general speech recognition model that comprises a general grammar set that is different that the first grammar set;
receive audio language input from a user;
match one or more spoken words within the audio language input to text-based words within the general grammar set and the first grammar set, wherein:
the first grammar set is associated with a higher match bias than the general grammar set, such that the speech recognition system is more likely to match the one or more spoken words to the text-based words within the first grammar set.

15. The computer system of claim 14, wherein associating the first language-based intelligent agent with the speech recognition system comprises:
receiving at the speech recognition system an identification invocation that is associated with the first language-based intelligent agent; and
associating the first grammar set with the general grammar set within the general speech recognition model.

16. The computer system of claim 14, wherein creating a first language-based intelligent agent further comprises associating a first-grammar-set match bias with the words and phrases within the first grammar set.

17. The computer system of claim 14, wherein creating a first language-based intelligent agent further comprises:
receiving an indication that a user intends to utilize the first language-based intelligent agent;
retrieving one or more attributes associated with the first language-based intelligent agent; and
creating a dynamically generated priming set that comprises particular words or phrases that are dynamically generated based upon the one or more attributes associated with the first language-based intelligent agent.

18. The computer system of claim 17, wherein the one or more attributes associated with the first language-based intelligent agent comprise a current geo-location of the user.

19. The computer system of claim 18, wherein the particular words or phrases within the dynamically generated priming set comprise names of points-of-interest that are within a threshold distance of the current geo-location of the user.

20. The computer system of claim 17, wherein the executable instructions include instructions that are executable to configure the computer system to associate a dynamically-generated-priming-set match bias with the words and phrases within the dynamically generated priming set.
